(19) United States
(12) Patent Application Publication
(10) Pub. No.: US 2012/0264009 A1
(43) Pub. Date: Oct. 18, 2012

(54) METHOD FOR MANUFACTURING POSITIVE ACTIVE MATERIAL FOR RECHARGEABLE LITHIUM BATTERY AND RECHARGEABLE LITHIUM BATTERY USING SAME

(75) Inventors: Min-Han KIM, Yongin-si (KR); Do-Hyung Park, Yongin-si (KR); Seon-Young Kwon, Yongin-si (KR); Yu-Mi Song, Yongin-si (KR); Ji-Hyun Kim, Yongin-si (KR); Kyoung-Hyun Kim, Yongin-si (KR)

(73) Assignee: Samsung SDI Co., Ltd., Yongin-si (KR)

(21) Appl. No.: 13/435,464

(22) Filed: Mar. 30, 2012

(30) Foreign Application Priority Data
Apr. 15, 2011 (KR) 10-2011-0035328

(51) Int. Cl. H01M 10/052; B05D 5/12; H01M 4/525; H01M 4/485; H01M 4/505

(52) U.S. Cl. 429/188; 429/211; 427/122

(57) ABSTRACT

A method of preparing a positive active material for a rechargeable lithium battery including a) mixing a composite metal precursor and a lithium compound; b) firing the mixture to prepare a positive active material; c) mixing the resulting positive active material, a carbon coating material, and a solvent; and d) heat-treating the resulting mixture to provide a positive active material coated with the carbon coating material, wherein the carbon coating material is used in an amount of 1 wt % to 30 wt % based on 100 wt % of the composite metal precursor, lithium compound, and carbon coating material, the firing is performed at 400 to 900° C., and the positive active material provided in d) is represented by the following Chemical Formula 1, is provided.

LiₐNiₓCo_{y}Mn_{z}M′ₖO₂ [Chemical Formula 1]

In Chemical Formula 1, each definition is the same as in the detailed description.

### CROSS-REFERENCE TO RELATED APPLICATIONS

This application claims priority to and the benefit of Korean Patent Application No. 10-2011-0035328 filed in the Korean Intellectual Property Office on Apr. 15, 2011, the entire contents of which are incorporated herein by reference.

### BACKGROUND

1. Field

This disclosure relates to a method of manufacturing a positive active material for a rechargeable lithium battery, and a rechargeable lithium battery including the same.

2. Description of the Related Technology

In recent times, due to reductions in size and weight of portable electronic equipment, there has been a need to develop batteries for use in the portable electronic equipment, where the batteries have both high performance and a large capacity.

Batteries generate electric power using an electrochemical reaction material for a positive electrode and a negative electrode. Rechargeable lithium batteries generate electrical energy from changes of chemical potential during intercalation/deintercalation of lithium ions at the positive and negative electrodes.

Rechargeable lithium batteries use materials that reversibly intercalate or deintercalate lithium ions during charge and discharge reactions for both positive and negative active materials, and contain an organic electrolyte or a polymer electrolyte between the positive electrode and the negative electrode.

For positive active materials of a rechargeable lithium battery, lithium composite metal compounds have been used, and lithium composite metal oxides such as LiCoO₂, LiMn₂O₄, LiNiO2, LiNi₁—ₓCoₓO₂ (0<x<1), LiMnO₂, or the like have been researched.

Of the positive active materials, manganese-based positive active materials such as LiMn₂O₄ or LiMnO₂ are the easiest to synthesize, are less costly than the other materials, have excellent thermal stability compared to the other active materials during overcharging, and are environmentally friendly. However, these manganese-based materials have relatively low capacity.

Among the commercially selling positive active material, LiCoO₂2 is a representative, since it has good electrical conductivity, high battery voltage of about 3.7V, excellent cycle-life characteristics, high stability, and excellent discharge capacity. However, since LiCoO₂ is expensive and is responsible for 30% or more of the total cost of a battery, it has disadvantages in terms of cost.

Also, LiNiO₂ has the highest discharge capacity battery characteristics among the mentioned positive active materials, but it is difficult to synthesize. Further, high oxidation states of nickel cause battery and electrode cycle-life deterioration, and bring about easy self-discharge and lowered reversibility. Furthermore, it is difficult to fabricate a commercially viable battery due to difficulties in ensuring stability.

### SUMMARY

One embodiment provides a method of preparing a positive active material that is economical, and has stability, high-capacity, improved electrical conductivity, and high rate capability.

According to one embodiment, a method of manufacturing a positive active material for a rechargeable lithium battery is provided that includes a) mixing a composite metal precursor and a lithium compound; b) firing the mixture to prepare a positive active material; c) mixing the resulting positive active material, a carbon coating material, and a solvent; and d) heat-treating the resulting mixture to provide a positive active material coated with the carbon coating material, wherein the carbon coating material is used in an amount of 1 wt % to 30 wt % based on 100 wt % of the composite metal precursor, lithium compound, and carbon coating material, the firing is performed at 400 to 900° C., and the positive active material provided in d) is represented by the following Chemical Formula 1.

LiₐNiₓCo_{y}Mn_{z}M′ₖO₂ [Chemical Formula 1]

In Chemical Formula 1, 0.45≦x≦0.65, 0.15≦y≦0.25, 0.15≦z≦0.35, 0≦k≦0.1, x+y+z+k=1, 0.9≦a≦1.2, and M′ is Al, Mg, Ti, Zr, or a combination thereof.

During the process b), firing may be performed in an air.

In some embodiments of Chemical Formula 1, 0.55≦x≦0.65, 0.15≦y≦0.25, 0.15≦z≦0.25, 0≦k≦0.1, and x+y+z+k=1.

In some embodiments, y and z may be the same.

The composite metal precursor and the lithium compound of the process b) may be mixed so that lithium of the lithium compound relative to the metal of the composite metal precursor may be present at a mole ratio of about 0.9 to about 1.2.

In one embodiment, the mole ratio of lithium of the lithium compound relative to the metal of the composite metal precursor may be about 0.97 to about 1.05.

The lithium compound of the process a) may include lithium carbonate, lithium nitrate, lithium acetate, lithium hydroxide, lithium hydroxide hydrate, lithium oxide, or a combination thereof.

The carbon coating material of the process c) may include sucrose, amylose, a water-soluble hydrocarbon compound, a thermoplastic polymer, a carbon powder, or a combination thereof.

The solvent of the process c) may be a solvent being capable of dissolving the carbon coating material, but being unable to dissolve the lithium compound.

The solvent may be methanol, ethanol, or a combination thereof.

In the process c), a lithium compensating compound may be further added to compensate loss of the lithium compound by the solvent.

The lithium compensating compound may include lithium carbonate, lithium nitrate, lithium acetate, lithium hydroxide, lithium hydroxide hydrate, lithium oxide, or a combination thereof.

According to another embodiment, a rechargeable lithium battery is provided that includes a positive electrode, a negative electrode, and an electrolyte, wherein the positive electrode includes a current collector and a positive active material layer disposed on the current collector, and the positive active material layer includes the positive active material prepared by the above method.

The electrolyte may include a non-aqueous organic solvent and a lithium salt.

The rechargeable lithium battery may further include a separator.

The separator may be a single-layer or multi-layer separator selected from polyethylene, polypropylene, or polyvinylidene fluoride.

The method of the embodiment may provide a positive active material which is economical, has stability, high-capacity, improved electrical conductivity, and high rate capability.

### BRIEF DESCRIPTION OF THE DRAWINGS

FIG. 1 is a SEM photograph showing a positive active material prepared according to Example 3.

FIG. 2 is a SEM photograph showing a positive active material prepared according to Comparative Example 2.

FIG. 3 is a schematic diagram of a rechargeable lithium battery according to one embodiment.

### DETAILED DESCRIPTION

Example embodiments will hereinafter be described in detail. However, these embodiments are only examples, and the present embodiments are not limited thereto.

According to one embodiment, a method of manufacturing a positive active material for a rechargeable lithium battery includes a) mixing a composite metal precursor and a lithium compound; b) firing the mixture to prepare a positive active material; c) mixing the resulting positive active material, a carbon coating material, and a solvent; and d) heat-treating the resulting mixture to provide a positive active material coated with the carbon coating material; wherein the carbon coating material is used in an amount of about 1 wt % to about 30 wt % based on 100 wt % of the composite metal precursor, the lithium compound, and the carbon coating material, the firing is performed at from about 400° C. to about 900° C., and the positive active material provided in d) is represented by the following Chemical Formula 1.

LiₐNiₓCo_{y}Mn_{z}M′ₖO₂ [Chemical Formula 1]

In Chemical Formula 1, 0.45≦x≦0.65, 0.15≦y≦0.25, 0.15≦z≦0.35, 0≦k≦0.1, x+y+z+k=1, 0.9≦a≦1.2, and M′ is Al, Mg, Ti, Zr, or a combination thereof.

During the process b), firing may be performed at from about 400° C. to about 800° C.

According to the manufacturing method, the positive active material coated with the carbon coating material on the surface may be prepared. The carbon coating material may have better electrical conductivity than a common positive active material. Accordingly, when used to fabricate a rechargeable lithium battery, the battery may have excellent performance due to this characteristic.

During the process b), firing may be performed in an air. Under this condition, CO₂ generated during the firing may be effectively removed. When CO₂ is effectively removed, a positive active material having a single phase with Liₐ NiₓCo_{y}Mn_{z}M′ₖO₂ may be provided.

In some embodiments, in Chemical Formula 1, 0.55≦x≦0.65, 0.15≦y≦0.25, 0.15≦z≦0.25, 0≦k<0.1, and x+y+z+k=1. Ni, Co, and Mn may have a mole ratio of about Ni:Co:Mn=6:2:2. Since this range is out of a conventional ternary positive active material, the positive active material may improve battery performance such as capacity, voltage retention, cycle characteristics, and the like.

In some embodiments, y and z may be the same. In some embodiments, Co and Mn may be present at the same mole ratio. When the y and z are within the range, battery capacity, cycle-life, stability, or the like may be improved.

The positive active material may be doped with Al, Mg, Ti, Zr, or a combination thereof through controlling the k value. The rechargeable lithium battery may have good high rate capability and initial capacity by controlling the doping within a suitable range.

The composite metal precursor and the lithium compound of the process b) may be mixed so that lithium of the lithium compound relative to a metal of the composite metal precursor may be present at a mole ratio of about 0.9 to about 1.2. In one embodiment, the mole ratio of lithium of the lithium compound relative to the metal of the composite metal precursor may be about 0.97 to about 1.05. When the mole ratio of lithium and the transition element is within the range, battery capacity may be improved.

During the process b), firing may be performed at from about 400 to about 900° C. More particularly, during the process b), firing may be performed at from about 400 to about 800° C. The temperature range is lower than a general firing temperature range. When firing is performed within the range, particle shapes may be controlled as well as possible, and capacity can be maximized.

For example, in order to improve battery capacity, a Ni-based positive active material including about 60 mol % or more of Ni based on 100 mol % of the total metals included in the precursor should be fired at less than about 800° C.

The lithium compound may include lithium carbonate, lithium nitrate, lithium acetate, lithium hydroxide, lithium hydroxide hydrate, lithium oxide, or a combination thereof, but is not limited thereto.

The carbon coating material of the process c) may include sucrose, amylose, a water-soluble hydrocarbon compound (e.g., carboxymethyl cellulose (CMC), hydroxypropyl methylcellulose (HPMC)), a thermoplastic polymer (e.g., polyethylene, polypropylene powder), a carbon powder (e.g., carbon black), and the like.

This carbon coating material may have better electrical conductivity than that of the positive active material. Accordingly, a positive active material coated with the carbon coating material on the surface may have better electrical conductivity than a common positive active material and thus, may improve characteristics of a rechargeable lithium battery.

The carbon coating material is used in an amount of about 1 wt % to about 30 wt % based on 100 wt % of the composite metal precursor, the lithium compound, and the carbon coating material. When the amount of the carbon coating material fallen into the above range, the effects such as an improvement of electrical conductivity may maximized and the specific capacity, rate capability and cycle-life characteristics are suitably maintained.

The solvent of the process c) may be a solvent capable of dissolving the carbon coating material, but unable to dissolve the lithium compound. Such a solvent may prevent loss of the lithium compound. Such a solvent may include an organic solvent such as ethanol, methanol, or a combination thereof; water; or a combination thereof

However, when a solvent such as water and the like is used instead of the solvent, there may be a problem of losing a lithium compound. Accordingly, the process c) may additionally include a lithium compensating compound to prevent the loss of a lithium compound. The lithium compensating compound may include lithium carbonate, lithium nitrate, lithium acetate, lithium hydroxide, lithium hydroxide hydrate, lithium oxide, or a combination thereof.

When the carbon coating material is used, a dispersing agent may be additionally included to disperse the carbon coating material well into the material (e.g., water). When the dispersing agent is used, powers of the carbon coating material may remain agglomerated or become agglomerated again during the drying even if dispersed, which may deteriorate the effect of using the carbon coating material. Accordingly, the carbon coating material may be dispersed in a solvent to obtain a dispersion, a fired positive active material powder is impregnated in the dispersion, and then dried.

According to one embodiment, a primarily heat-treated powder impregnating a carbon coating material is dry-mixed in a mechanical/chemical method to uniformly combine the carbon coating material on the surface of a primarily heat-treated positive active material powder.

The dry mixing may be performed by using a ball mill or by a high energy mill such as a planetary mill, a SPEX mill, a vibration mill, an attrition mill, and the like, which can increase the temperature of a powder, since the ball mill takes a longer time to uniformly mix a carbon coating material.

During the process d), the heat-treatment may be performed at a temperature of 400° C. to 700° C. When the heat-treatment is performed at the above temperature range, the moisture amount in the obtained positive active material may be suitable controlled, and the effect by coating the carbon material may be sufficiently obtained.

According to another embodiment, a rechargeable lithium battery includes a positive electrode, a negative electrode, and an electrolyte, wherein the positive electrode includes a current collector and a positive active material layer disposed on the current collector, and the positive active material layer includes the positive active material.

Since the positive active material is the same as in the embodiment described above, it is not described again hereafter.

The positive active material layer may include a binder and a conductive material.

The binder improves binding properties of the positive active material particles to each other and to a current collector. Examples of the binder include at least one selected from the group consisting of polyvinyl alcohol, carboxylmethyl cellulose, hydroxypropyl cellulose, polyvinyl chloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, or the like, but are not limited thereto.

The conductive material is included to improve electrode conductivity. Any electrically conductive material may be used as a conductive material unless it causes a chemical change. Examples of the conductive material include: a carbon-based material such as natural graphite, artificial graphite, carbon black, acetylene black, ketjen black, a carbon fiber, and the like; a metal-based material such as a metal powder or a metal fiber including copper, nickel, aluminum, silver, and the like; a conductive polymer such as a polyphenylene derivative; or mixtures thereof.

The negative electrode includes a current collector and a negative active material layer disposed thereon, and the negative active material layer includes a negative active material.

The negative active material may include a material that reversibly intercalates/deintercalates lithium ions, a lithium metal, a lithium metal alloy, a material being capable of doping and dedoping lithium, or a transition metal oxide.

The material that reversibly intercalates/deintercalates lithium ions includes a carbon material. The carbon material may be any generally-used carbon-based negative active material for a lithium ion rechargeable battery. Examples of the carbon material include crystalline carbon, amorphous carbon, or a mixture thereof The crystalline carbon may be non-shaped, or sheet, flake, spherical, or fiber shaped natural graphite or artificial graphite. The amorphous carbon may be a soft carbon, a hard carbon, mesophase pitch carbide, fired coke, or the like.

Examples of the lithium metal alloy includes lithium and at least one metal selected from Na, K, Rb, Cs, Fr, Be, Mg, Ca, Sr, Si, Sb, Pb, In, Zn, Ba, Ra, Ge, Al, and Sn.

Examples of the material being capable of doping and dedoping lithium include Si, SiOₓ (0<x<2), a Si—Y alloy (where Y is an element selected from the group consisting of an alkaline metal, an alkaline-earth metal, a group 13 element, a group 14 element, a group 15 element, a group 16 element, a transition element, a rare earth element, and combinations thereof, and is not Si), Sn, SnO₂, a Sn—Y alloy (where Y is an element selected from the group consisting of an alkaline metal, an alkaline-earth metal, a group 13 element, a group 14 element, a group 15 element, a group 16 element, a transition element, a rare earth element, and combinations thereof, and is not Sn), and mixtures thereof. At least one of these materials may be mixed with SiO₂. The element Y is selected from Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ti, Ge, P, As, Sb, Bi, S, Se, Te, Po, or a combination thereof.

Examples of the transition metal oxide include vanadium oxide, lithium vanadium oxide, or the like.

The negative active material layer includes a binder and optionally a conductive material.

The binder improves binding properties of the negative active material particles to each other and to a current collector, and includes polyvinyl alcohol, carboxylmethyl cellulose, hydroxypropyl cellulose, polyvinylchloride, carboxylated polyvinylchloride, polyvinylfluoride, polyethylene oxide, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, or nylon, but is not limited thereto.

The conductive material is included to improve electrode conductivity. Any electrically conductive material may be used as a conductive material unless it causes a chemical change. Examples of the conductive material include: carbon-based materials such as natural graphite, artificial graphite, carbon black, acetylene black, ketjen black, carbon fiber, and the like; metal-based materials including a metal powder or a metal fiber of copper, nickel, aluminum, silver, and the like; conductive polymers of polyphenylene derivatives; or mixtures thereof.

The current collector may be selected from a copper foil, a nickel foil, a stainless steel foil, a titanium foil, a nickel foam, a copper foam, a polymer substrate coated with a conductive metal, or a combination thereof.

The current collector may include Al, but is not limited thereto.

The negative electrode and the positive electrode may be fabricated by mixing a negative active material, a conductive material, and a binder in a solvent to prepare an active material composition, and coating the composition on a current collector. The electrode manufacturing method is well known, and thus is not described in detail in the present specification. The solvent may include N-methylpyrrolidone, or the like, but is not limited thereto.

The electrolyte may include a non-aqueous organic solvent and a lithium salt.

The non-aqueous organic solvent plays a role of transferring ions that are related to an electrochemical reaction of a battery.

The non-aqueous organic solvent may include carbonate-based, ester-based, ether-based, ketone-based, alcohol-based, or aprotic solvent. Examples of the carbonate-based solvent include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and examples of the ester-based solvent include methyl acetate, ethyl acetate, n-propyl acetate, dimethyl acetate, methylpropionate, ethylpropionate, γ-butyrolactone, decanolide, valerolactone, mevalonolactone, caprolactone, or the like. Examples of the ether-based solvent may include dibutyl ether, tetraglyme, diglyme, dimethoxyethane, 2-methyltetrahydrofuran, tetrahydrofuran, or the like, and examples of the ketone-based solvent may include cyclohexanone or the like. Examples of the alcohol-based solvent may include ethanol, isopropyl alcohol, and so on, and examples of the aprotic solvent may include R—CN (wherein R is a C2 to C20 linear, branched, or cyclic hydrocarbon group, and may include a double bond, an aromatic ring, or an ether bond), amides such as dimethylformamide, dioxolanes such as 1,3-dioxolane, sulfolanes, and the like.

The non-aqueous organic solvent may be used singularly or as a mixture. When the organic solvent is used as a mixture, the mixture ratio may be controlled in accordance with desirable battery performance.

The carbonate-based solvent may include a mixture of a cyclic carbonate and a linear carbonate. The cyclic carbonate and the linear carbonate are mixed together in a volume ratio of about 1:1 to about 1:9, and when the mixture is used as an electrolyte, the electrolyte performance may be enhanced.

In addition, the electrolyte of one embodiment may further include mixtures of carbonate-based solvents and aromatic hydrocarbon-based solvents. The carbonate-based solvents and the aromatic hydrocarbon-based solvents are mixed together in a volume ratio of about 1:1 to about 30:1.

The aromatic hydrocarbon-based organic solvent may be represented by the following Chemical Formula 2.

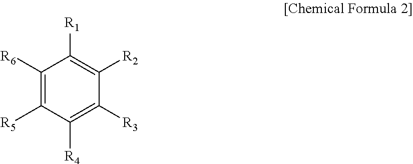

In Chemical Formula 2, R₁ to R₆ are the same or different, and are hydrogen, a halogen, a C1 to C10 alkyl, a C1 to C10 haloalkyl, or a combination thereof.

Examples of the aromatic hydrocarbon-based organic solvent include benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 1,2-difluorotoluene, 1,3-difluorotoluene, 1,4-difluorotoluene, 1,2,3-trifluorotoluene, 1,2,4-trifluorotoluene, chlorotoluene, 1,2-dichlorotoluene, 1,3-dichlorotoluene, 1,4-dichlorotoluene, 1,2,3-trichlorotoluene, 1,2,4-trichlorotoluene, iodotoluene, 1,2-diiodotoluene, 1,3-diiodotoluene, 1,4-diiodotoluene, 1,2,3-triiodotoluene, 1,2,4-triiodotoluene, xylene, or a combination thereof.

In order to improve a battery cycle-life, the non-aqueous electrolyte may further include vinylene carbonate or an ethylene carbonate-based compound of the following Chemical Formula 3.

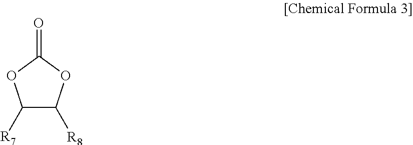

In Chemical Formula 3, R₇ and R₈ are the same or different, and are independently hydrogen, a halogen, a cyano group (CN), a nitro group (NO₂), or a C1 to C5 fluoroalkyl group, provided that at least one of R₇ and R₈ is halogen, a cyano group (CN), a nitro group (NO₂), or a C1 to C5 fluoroalkyl.

The ethylene carbonate-based compound includes difluoroethylene carbonate, chloroethylene carbonate, dichloroethylene carbonate, bromoethylene carbonate, dibromoethylene carbonate, nitroethylene carbonate, cyanoethylene carbonate, or fluoroethylene carbonate. The use amount of the additive for improving cycle life may be adjusted within an appropriate range.

The lithium salt supplies lithium ions in the battery, and operates a basic operation of a rechargeable lithium battery and improves lithium ion transport between positive and negative electrodes. Non-limiting examples of the lithium salt include at least one supporting salt selected from LiPF₆, LiBF₄, LiSbF₆, LiAsF₆, LiC₄F₉9SO₃, LiClO₄, LiAlO₂, LiAlCl₄, LiN(SO₃C₂F₅)₂, Li(CF₃SO₂)₂N, LiN(SO₃C₂F₅)₂, LiC₄F₉SO₃, LiClO₄, LiAlO₂, LiAlCl₄, LiN(CₓF₂ₓ₊₁SO₂)(C_{y}F₂y+₁SO₂), (where x and y are natural numbers), LiCl, Lil, and LiB(C₂O₄)₂ (lithium bisoxalato borate, LiBOB). The lithium salt may be used at a concentration of about 0.1 to about 2.0M. When the lithium salt is included at the above concentration range, electrolyte performance and lithium ion mobility may be enhanced due to optimal electrolyte conductivity and viscosity.

The rechargeable lithium battery may further include a separator between a negative electrode and a positive electrode, as needed. Non-limiting examples of suitable separator materials include polyethylene, polypropylene, polyvinylidene fluoride, and multi-layers thereof such as a polyethylene/polypropylene double-layered separator, a polyethylene/polypropylene/polyethylene triple-layered separator, and a polypropylene/polyethylene/polypropylene triple-layered separator.

Rechargeable lithium batteries may be classified as lithium ion batteries, lithium ion polymer batteries, and lithium polymer batteries according to the presence of a separator and the kind of electrolyte used in the battery. The rechargeable lithium batteries may have a variety of shapes and sizes, and include cylindrical, prismatic, or coin-type batteries, and may be thin film batteries or may be rather bulky in size. Structures and fabricating methods for lithium ion batteries pertaining to this disclosure are well known in the art.

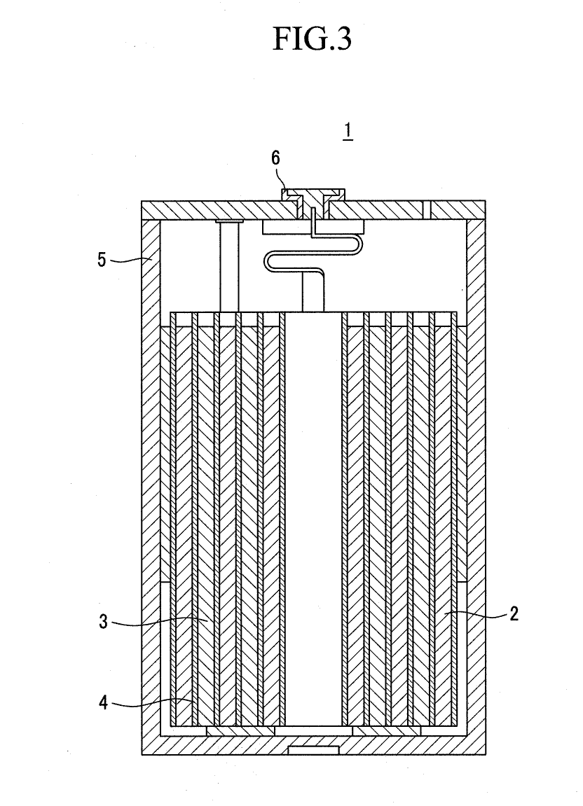

FIG. 3 is a schematic view of a representative structure of a rechargeable lithium battery. FIG. 3 illustrates a rechargeable lithium battery 1, which includes a positive electrode 3, a negative electrode 2, a battery case 5 including an electrolyte solution impregnating a separator 4 that is interposed between the positive electrode 3 and the negative electrode 2, and a sealing member 6 sealing the battery case 5.

The following examples illustrate the present embodiments in more detail. These examples, however, should not in any sense be interpreted as limiting the scope of the present embodiments.

### EXAMPLES

### Example 1

### Preparation of a Positive Active Material

NiSO₄, CoSO₄, and MnSO₄ were mixed in a water solvent to prepare a precursor liquid. At this time, the mixing ratio of NiSO₄, CoSO₄, and MnSO₄ were controlled in order to have the mole ratio of Ni, Co and Mn in the final product being 6:2:2, and the mole concentration of the liquid was 2.5M.

Herein, as for the NiSO₄, its raw material including NiSO₄ and impurities included Fe in an amount of 0.002 wt % or less and Co in an amount of 0.001 wt % or less based on 100 wt % of the total amount thereof; as for the CoSO₄, its raw material including CoSO₄ and impurities included Fe in an amount of 0.0005 wt % or less and Cu in an amount of 0.0003 wt % or less, Si in an amount of 0.0025 wt % or less, and Na in an amount of 0.0015 wt % or less based on 100 wt % of the total amount thereof; and as for MnSO₄, its raw material including MnSO₄ and impurities included Fe in an amount of 0.0005 wt % or less, Ca in an amount of 0.01 wt % or less, Na in an amount of 0.01 wt % or less, and K in an amount of 0.01 wt % or less based on 100 wt % of the total amount thereof.

The precursor liquid, NH₄OH and NaOH were added to a reactor to perform a co-precipitation, thereby obtaining a co-precipitator of Ni, Co and Mn. At this time, the pH in the reactor was maintained about 11 to 12, a reaction temperature was 40° C., and a speed of the shaking was 600rpm. Furthermore, the average duration time was 8 hours and the co-precipitation was performed by blowing N₂ at 1 LPM.

After the reaction, transition element precursor hydroxide products were several times gathered and rinsed and then, dried in a 120° C. oven. Then, Li₂CO₃ was added to the dried transition element precursor hydroxide to have a Li/transition element ratio of 1.03. The mixture was well mixed using a hand mixer. The resulting product was fired at a temperature ranging from 870° C. for 10 hours, preparing a LiNi_{0.6}Co_{0.2}Mn_{0.2} product.

The product was added to a solution prepared by dissolving 200 g of sucrose in 1L of ethanol and mixed therewith. The mixture was dried in a 120° C. oven. The dried positive active material was heat-treated at a temperature ranging from 700° C. for 2 hours to coat the positive active material with sucrose. The amount of the coated sucrose was 1 wt % based on the total positive active material.

### Example 2

### Preparation of a Positive Active Material

A positive active material was prepared according to the same method as positive active material except for preparing a solvent by dissolving 200 g of sucrose and 12.7 g of Li₂CO₃ in 1L of water and adding the LiNi_{0.6}Co_{0.2}Mn_{0.2} product prepared by Example 1 to the solvent.

### Comparative Example 1

### Preparation of a Positive Active Material

NiSO₄ was mixed with CoSO₄ and MnSO₄ respectively in an amount of 25.1 g, 8.7 g, and 5.2 g and consecutively reacted together in co-precipitator.

The co-precipitation was performed for 8 hours at 40° C. at a speed of 600 rpm.

After the reaction, the transition element precursor hydroxide products was gathered and rinsed and then, dried in a 120° C. oven. Then, Li₂CO₃ was added to the dried transition element precursor hydroxide to have a Li/transition element ratio of 1.03. The mixture was mixed using a hand mixer. The mixed reactant was fired at a temperature ranging from 800 to 900° C. for 10 hours, preparing a positive active material.

### Example 3

### Fabrication of a Half-Cell

The positive active material according to Example 1, a polyvinylidenefluoride binder, and a carbon conductive agent were dispersed in a weight ratio of 96:2:2 into an N-methylpyrrolidone solvent, preparing a positive slurry. The positive slurry was coated to be 60 μm thick on an aluminum foil, dried at 135° C. for 3 hours, and compressed, fabricating a thin positive electrode.

Using the thin positive electrode and lithium metal as a counter electrode, a polyethylene separator was disposed between the positive electrode and the counter electrode, and an electrolyte was injected therein, fabricating a coin-type half-cell. The electrolyte was prepared by dissolving 1.3M of LiPF6 in a mixed solvent prepared by mixing ethylene carbonate (EC), ethylmethylcarbonate (EMC), and dimethylcarbonate (DMC) in a volume ratio of 2:2:6.

### Example 4

### Fabrication of a Coin-Type Half-Cell

A coin-type half cell was fabricated according to the same method as in Example 3 except for using the positive active material of Example 2 instead of the positive active material of Example 1.

### Comparative Example 2

### Fabrication of a Coin-Type Half-Cell

A coin-type half cell was fabricated according to the same method as in Example 3 except for using a positive active material of Comparative Example 1 instead of the positive active material of Example 1.

### EXPERIMENTAL EXAMPLE

### Scanning Electron Microscope (SEM)

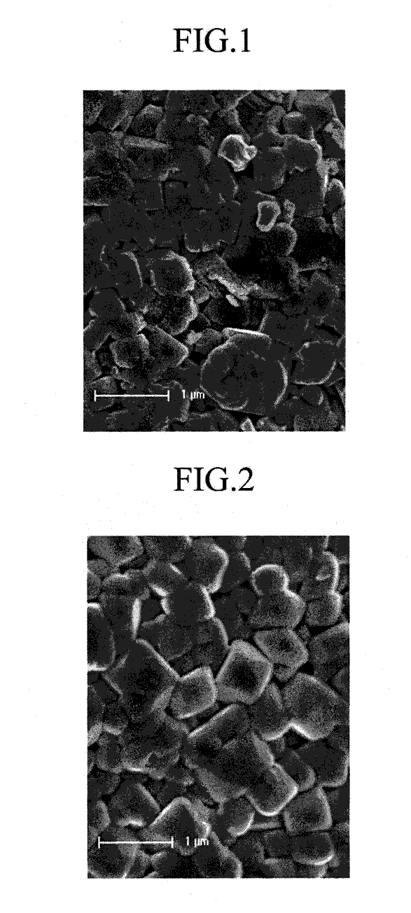

FIG. 1 is a SEM photograph showing a positive active material prepared according to Example 3, and FIG. 2 is a SEM photograph showing a positive active material prepared according to Comparative Example 2.

As shown in FIG. 1, carbon was uniformly coated on the surface of the positive active material.

### Battery Cell Performance

Battery cell performance of the coin cells according to Examples 3 and 4 and Comparative Example 2 are shown in the following Table 1.

| | | Discharge | Charge | Charge and | Charge | Rate |
|---|---|---|---|---|---|---|
| | | capacity | capacity at | discharge | capacity | capability |
| | Conductivity | at 0.1 C | 0.1 C | efficiency | at 1 C | 1 C/0.1 C |
| | (S/cm) | (mAh/g) | (mAh/g) | (%) | (mAh/g) | (%) |
| Comparative | 3.12 × 10⁻³ | 198 | 180.6 | 91.2 | 158.3 | 87.6 |
| Example 2 | | | | | | |
| Example 3 | 9.83 × 10⁻² | 199.4 | 185.1 | 92.8 | 163.4 | 88.3 |
| Example 4 | 3.16 × 10⁻² | 198.3 | 183.5 | 92.5 | 163.3 | 89.0 |

As shown in Table 1, the cells of Examples 3 and 4 had significantly improved charge and discharge efficiency and rate capability compared to that of Comparative Example 2.

While this disclosure has been described in connection with what is presently considered to be practical example embodiments, it is to be understood that the embodiments are not limited to the disclosed embodiments, but, on the contrary, is intended to cover various modifications and equivalent arrangements included within the spirit and scope of the appended claims. Therefore, the above-mentioned embodiments are examples but do not limit in any sense.

What is claimed is:

1. A method of manufacturing a positive active material for a rechargeable lithium battery, comprising:
a) mixing a composite metal precursor and a lithium compound;
b) firing the mixture to prepare a positive active material;
c) mixing the resulting positive active material, a carbon coating material, and a solvent; and
d) heat-treating the resulting mixture to provide a positive active material coated with the carbon coating material,
wherein the carbon coating material is used in an amount of from about 1 wt % to about 30 wt % based on 100 wt % of the composite metal precursor, lithium compound, and carbon coating material,
the firing is performed at from about 400° C. to about 900° C., and
the positive active material provided in step d) is represented by the following Chemical Formula 1,
LiₐNiₓCo_{y}Mn_{z}M′ₖO₂ [Chemical Formula 1]
wherein, 0.45≦x≦0.65, 0.15≦y≦0.25, 0.15≦z≦0.35, 0≦k≦0.1, x+y+z+k=1,
0.9≦a≦1.2, and M′ is Al, Mg, Ti, Zr, or a combination thereof.

2. The method of claim 1, wherein the firing is performed in air.

3. The method of claim 1, wherein 0.55≦x≦0.65, 0.15≦y≦0.25, 0.15≦z≦0.25, 0≦k≦0.1, and x+y+z+k=1.

4. The method of claim 3, wherein the y and z are the same.

5. The method of claim 1, wherein the composite metal precursor and the lithium compound are mixed so that lithium of the lithium compound relative to the metal of the composite metal precursor is present at a mole ratio of about 0.9 to about 1.2.

6. The method of claim 5, wherein the mole ratio of lithium of the lithium compound relative to the metal of the composite metal precursor is about 0.97 to about 1.05.

7. The method of claim 1, wherein the lithium compound of step a) comprises lithium carbonate, lithium nitrate, lithium acetate, lithium hydroxide, lithium hydroxide hydrate, lithium oxide, or a combination thereof

8. The method of claim 1, wherein the carbon coating material comprises sucrose, amylose, a water-soluble hydrocarbon compound, a thermoplastic polymer, a carbon powder, or a combination thereof

9. The method of claim 1, wherein the solvent is capable of dissolving the carbon coating material, but unable to dissolve the lithium compound.

10. The method of claim 9, wherein the solvent is methanol, ethanol or a combination thereof

11. The method of claim 1, wherein in step c), a lithium compensating compound is further added to compensate for the loss of the lithium compound by the solvent.

12. The method of claim 11, wherein the lithium compensating compound comprises lithium carbonate, lithium nitrate, lithium acetate, lithium hydroxide, lithium hydroxide hydrate, lithium oxide, or a combination thereof

13. A rechargeable lithium battery comprising
a positive electrode, a negative electrode, and an electrolyte,
wherein the positive electrode comprises a current collector and a positive active material layer disposed on the current collector,
wherein the positive active material is manufactured by the method comprising:
e) mixing a composite metal precursor and a lithium compound;
f) firing the mixture to prepare a positive active material;
g) mixing the resulting positive active material, a carbon coating material, and a solvent; and
h) heat-treating the resulting mixture to provide a positive active material coated with the carbon coating material,
wherein the carbon coating material is used in an amount of from about 1 wt % to about 30 wt % based on 100 wt % of the composite metal precursor, lithium compound, and carbon coating material,
the firing is performed at from about 400° C. to about 900° C., and
the positive active material provided in step d) is represented by the following Chemical Formula 1,
LiₐNiₓCo_{y}Mn_{z}M′ₖO₂ [Chemical Formula 1]
wherein, 0.45≦x≦0.65, 0.15≦y≦0.25, 0.15≦z≦0.35, 0≦k≦0.1, x+y+z+k=1, 0.9≦a≦1.2, and M′ is Al, Mg, Ti, Zr, or a combination thereof.

14. The rechargeable lithium battery of claim 13, wherein the electrolyte comprises a non-aqueous organic solvent and a lithium salt.

15. The rechargeable lithium battery of claim 13, wherein the firing is performed in air.

16. The rechargeable lithium battery of claim 13, wherein 0.55≦x≦0.65, 0.15≦y≦0.25, 0.15≦z≦0.25, 0≦k≦0.1, and x+y+z+k=1.

17. The rechargeable lithium battery of claim 16, wherein the y and z are the same.

18. The rechargeable lithium battery of claim 13, wherein the composite metal precursor and the lithium compound are mixed so that lithium of the lithium compound relative to the metal of the composite metal precursor is present at a mole ratio of about 0.9 to about 1.2.

19. The rechargeable lithium battery of claim 18, wherein the mole ratio of lithium of the lithium compound relative to the metal of the composite metal precursor is about 0.97 to about 1.05.

20. The rechargeable lithium battery of claim 13, wherein the lithium compound of step a) comprises lithium carbonate, lithium nitrate, lithium acetate, lithium hydroxide, lithium hydroxide hydrate, lithium oxide, or a combination thereof.
